(19) United States
(12) Patent Application Publication
(10) Pub. No.: US 2012/0278097 A1
(43) Pub. Date: Nov. 1, 2012

(54) Creating and Visualizing Professionally Crowdsourced Structured Medical Knowledge

(75) Inventors: Ahmed F. Ghouri, League City, TX (US); Omar Baig, San Jose, CA (US)

(73) Assignee: PHYSICIAN NEXUS INC., San Jose, CA (US)

(21) Appl. No.: 13/458,997

(22) Filed: Apr. 27, 2012

Related U.S. Application Data
(60) Provisional application No. 61/481,124, filed on Apr. 29, 2011.

(51) Int. Cl. G06Q 50/22

(52) U.S. Cl. 705/2

(57) ABSTRACT

A system and a method are disclosed for gathering and visualizing votes on the comparative efficacy, tolerability, and cost of medical treatments, including surgeries, drugs, devices, radiological and other procedures and interventions, using an Internet-based, credentialed physician social network. The system includes a method for intuitive head-to-head visualization of competing treatments, based upon aggregated community physician votes, with respect to their performance on the principal clinical dimensions of efficacy, tolerability, and cost. The system additionally includes a method to reduce intentional and unintentional voting bias.

### CROSS REFERENCE TO RELATED APPLICATIONS

This application claims the benefit of U.S. Provisional Application No. 61/481,124, filed Apr. 29, 2011, which is incorporated by reference in its entirety.

### BACKGROUND

The Internet has enabled new methods of sharing of facts among groups of users that are not formally organized through an organization such as a company, an institution, or association. For example, a wiki like WIKIPEDIA (www.Wikipedia.org) creates data that is shared and maintained by a community of contributors who are not employed by the organization that hosts WIKIPEDIA. The data on WIKIPEDIA is readily available to anyone without a fee, and virtually anyone can add or edit to the shared and ever-increasing collection of articles.

There are numerous examples of similar wikis within specific domains (e.g., botany) that serve as a common repository of documents that are continually read by a community of users in an unrestricted format. In addition to being free (or relatively low cost), the magnitude of shared contribution promotes collegiality and creates a collective expertise that is not be possible by a small number of individual authors within a single organization. As of March 2011, there were an estimated 17,000,000 articles in 270 languages on Wikipedia alone, created in a time period measured in just a few years.

Despite the dissemination of information enabled through a wiki, the wiki medium has not been able to make major advances in the field of medicine. There are at least two significant limitations to wiki approaches as currently employed in the field of medicine. The first is that a collection of articles, even if curated by a community, is not equivalent to a medical knowledgebase that can be queried as a relational database, and amenable to quantitative analysis at high level of granularity. One reason this exists is that analytical functions cannot be readily imposed upon free text. For example, it is virtually impossible to ask through a wiki “How many living Senators are female?” despite there being an article on every Senator with a date of birth, mention of gender, and date of death, if deceased.

Second, even if analytical functions could successfully be applied to free text, the veracity of data remains unknown to the community because the underlying data itself may be flawed. For example, it is difficult to determine the veracity of information (accuracy) of an article in WIKIPEDIA. Transposing such issues to the medical field would raise concerns for its user community. For example, if a wiki entry accumulated votes from physicians on the efficacy, tolerability, or price of a treatment, it would not be readily known if voting physicians were biased (e.g., industry consultants and employees with stock options voting favorably) or unreliable (e.g., clerical errors made during the voting process).

Third, the measurement of the comparative value of treatments is pivotally related to the attributes of patients for which they are administered. It is not possible to reliably compare treatments, whether for tolerability or efficacy, between two groups that differ markedly in age, gender, or disease class or severity, as is well known in modern clinical trials. This is one reason that regulatory agencies, such as the U.S. Food and Drug Administration (“FDA”), require both treatment groups and control groups be similar in terms of these parameters before statistical comparisons are made and submitted to authorities for review.

Another problem is that large volumes of data pertaining to comparative efficacy, tolerability, and cost are not visualizable in a rapid and clinically easy to interpret format. For example, comparing 10 treatments by each of three principal dimensions—efficacy, tolerability, cost—in patients of either gender, and up to ten decades of life, results in 10×3×2×10=600 distinct treatment groups. Presenting 600 subgroups to a physician in a comparative manner is not readily achievable with respect to these three clinical dimensions.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of components of an example machine able to read instructions from a machine-readable medium and execute them in a processor (or controller).

FIG. 2A illustrates one example embodiment of an information and flow in a system configuration for creating and visualizing structured medical knowledge on treatment efficacy, tolerability, and cost.

FIG. 2B illustrates one example embodiment of representative integers that are used as symbols for common treatments.

FIG. 3 illustrates one example of a physician bias scoring system.

FIG. 4 illustrates one example of classes for a high clinical utility functional disease classification system.

FIG. 5 illustrates one example embodiment of a normalized voting scale for principal clinical dimensions.

FIG. 6 illustrates one example embodiment of a voting screen that a user may interact with on a computing system.

FIG. 7 illustrates an example embodiment of an interface for defining data visualization.

FIG. 8 illustrates one example embodiment to further refine a query.

FIG. 9 illustrates one example embodiment of a user interface generated to illustrate effectiveness of treatment to tolerability.

FIG. 10 illustrates one example embodiment of a user interface generated to illustrate effectiveness of treatment to price.

FIG. 11 illustrates one example embodiment of a user interface generated to illustrate effectiveness of treatment with respect to branded or generic treatment solutions.

FIG. 12 illustrates one example embodiment of a user interface generated on a smart phone for use of the configurations as disclosed for both voting purposes and visualization.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

According to one aspect of the disclosed configuration, there is provided a computer-implemented method of creating and visualizing structured medical knowledge. The method comprises verifying the credentials of each of a plurality of physicians; receiving a plurality of votes from the plurality of physicians, the plurality of inputs comprising one or more votes from each of the plurality of physicians and the votes comprising scores for an efficacy, a tolerability, and a cost of a treatment for an indication or a disease. The method also comprises determining reliability of each of the plurality of votes by determining a voting history for each physician; for a plurality of reliable votes, analyzing scores for the efficacy, tolerability, and cost of the treatment for the indication or the disease; and providing a visual representation of data to a viewing user, the visual representation comprising scores for efficacy, tolerability or cost of the treatment.

In certain embodiments, the method includes requiring the user to select from one or more structured data inputs for the indication or the disease. The method also includes providing the user with one or more structured data inputs for the scores for efficacy, tolerability, or cost of the treatment.

In some embodiments, determining the voting history includes determining a voting velocity, a clinical dimension, or a volume of experience of the physician. In other embodiments, providing the visual representation of the data to the viewing user includes presenting data for one or more selected indications or diseases. Providing a visual representation of the data to a viewing user can include presenting data for at least two of the following parameters: efficacy, tolerability, or cost of the treatment. In some embodiments, analyzing scores for the efficacy, tolerability, and cost of the treatment includes averaging the scores for each of the efficacy, tolerability, or cost of the treatment.

According to a second aspect of the disclosed configuration, there is provided a computer-implemented method for creating and visualizing structured medical knowledge that includes: receiving a plurality of inputs from a plurality of users, the inputs comprising structured data inputs for an efficacy, a tolerability, and a cost of a treatment for an indication or a disease, and verifying that each of the plurality of users is a physician. For each of the plurality of inputs, the method includes: determining reliability of the input; analyzing the data about the treatment for the indication or the disease; and presenting for display a visual representation of the data to a viewing user, the visual representation comprising scores for efficacy, tolerability or cost of the treatment.

In one embodiment, the step for verifying that each of the plurality of users is a physician comprises analyzing the credentials of the user. The step for determining reliability of the input can include determining a voting velocity of a physician using limits for plausibility of the input by the physician. In some embodiments, the step for determining reliability of the input includes determining a clinical dimension or a volume of experience of a physician.

In another embodiment, the method includes requiring the user to select from one or more structured data inputs for the indication or the disease. The method also comprises requiring the user to select from one or more structured data inputs for a severity or a class of the indication or the disease. In alternative embodiments, the method includes requiring the user to select from one or more structured data inputs for an age or a gender of a patient. The method also includes providing the user with one or more structured data inputs for the scores for the efficacy, tolerability, or cost of the treatment.

In some embodiments, analyzing the data about the treatment for the indication or the disease comprises aggregating the data for each of a plurality of scores for efficacy, tolerability, or cost of the treatment, and determining an average score for each of the efficacy, tolerability, or cost of the treatment.

In another embodiment, providing a visual representation of the data to a viewing user comprises a graphical representation of at least two of the averaged scores for efficacy, tolerability, or cost of the treatment. The method also includes presenting a visual representation of data for a comparison of at least two different treatments for the indication or disease. In certain embodiments, presenting for display a visual representation of the data to a viewing user comprises presenting data for the efficacy of a branded treatment to a generic treatment for the indication or disease.

According a third aspect of the disclosed configuration, the method provides a non-transitory, computer-readable storage medium storing executable computer program instructions for creating and visualizing structured medical knowledge, the computer program instructions comprising: receiving a plurality of inputs from a plurality of users, the inputs comprising structured data inputs for an efficacy, a tolerability, and a cost of a treatment for an indication or a disease, and then verifying that each of the plurality of users is a physician. The computer program instructions also include steps for each of the plurality of inputs: determining reliability of the input; analyzing the data about the treatment for the indication or the disease; and presenting for display a visual representation of the data to a viewing user, wherein the visual representation includes scores for efficacy, tolerability or cost of the treatment.

In another embodiment, verifying that each of the plurality of users is a physician comprises instructions for analyzing the credentials of the user. In yet another embodiment, determining reliability of the input comprises instructions for determining a voting velocity of a physician using limits for plausibility of the input by the physician.

In certain embodiments, determining reliability of the input comprises determining a clinical dimension or a volume of experience of a physician. The computer program instructions can further comprise requiring the user to select from one or more structured data inputs for the indication or the disease. In other embodiments, the computer program instructions include requiring the user to select from one or more structured data inputs for a severity or a class of the indication or the disease. The instructions can include requiring the user to select from one or more structured data inputs for an age or a gender of a patient. In another embodiment, the instructions include providing the user with one or more structured data inputs for the scores for the efficacy, tolerability, or cost of the treatment.

In yet another embodiment, the computer program instructions for analyzing the data about the treatment for the indication or the disease comprises: aggregating the data for each of a plurality of scores for efficacy, tolerability, or cost of the treatment; and determining an average score for each of the efficacy, tolerability, or cost of the treatment.

In other embodiments, the computer program instructions for providing a visual representation of the data to a viewing user comprises a graphical representation of at least two of the averaged scores for efficacy, tolerability or cost of the treatment. The instructions can further comprise presenting a visual representation of data for a comparison of at least two different treatments for the indication or disease. The computer program instructions for presenting for display a visual representation of the data to a viewing user can include presenting data for the efficacy of a branded treatment to a generic treatment for the indication or disease.

### Example Computing Architecture

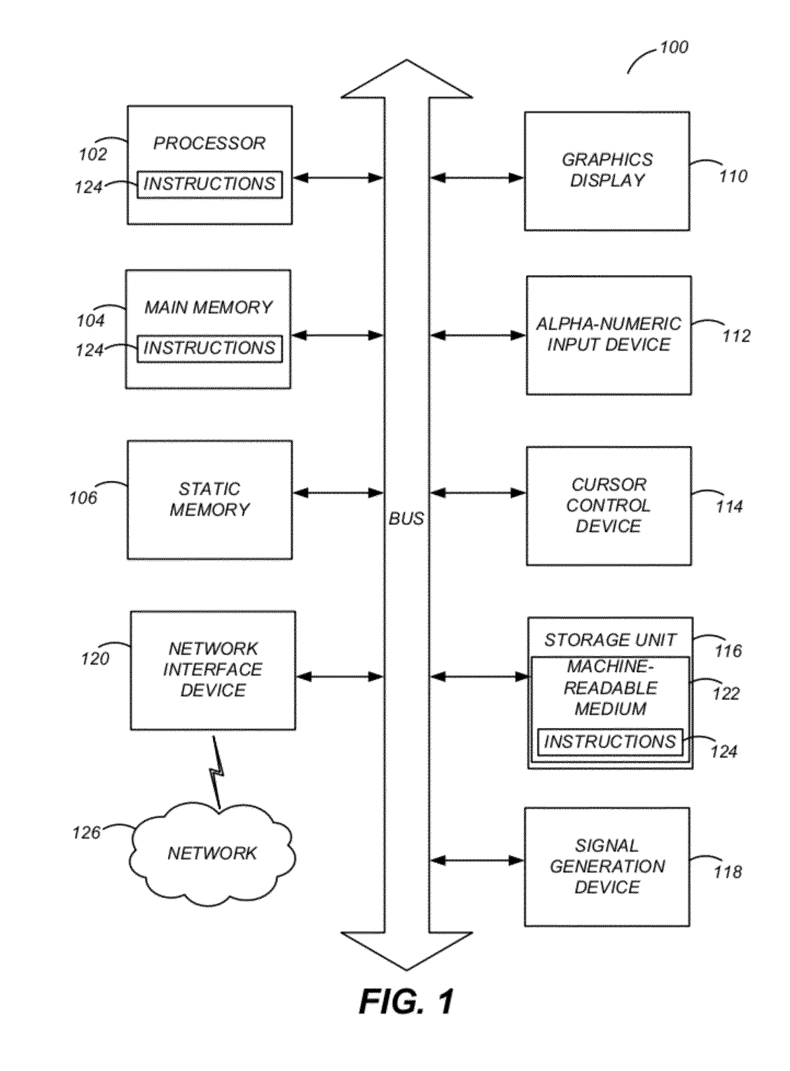

FIG. 1 is a block diagram illustrating components of an example machine able to read instructions from a machine-readable medium and execute them in a processor (or controller). Specifically, FIG. 1 shows a diagrammatic representation of a machine in the example form of a computer system 100 within which instructions 124 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 124 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 100 includes a processor 102 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 104, and a static memory 106, which are configured to communicate with each other via a bus 108. The computer system 100 may further include graphics display unit 110 (e.g., a plasma display panel (PDP), a liquid crystal display (LCD), a projector, or a cathode ray tube (CRT)). The computer system 100 may also include alphanumeric input device 112 (e.g., a keyboard), a cursor control device 114 (e.g., a mouse, a trackball, a joystick, a motion sensor, or other pointing instrument), a storage unit 116, a signal generation device 118 (e.g., a speaker), and a network interface device 120, which also are configured to communicate via the bus 108.

The storage unit 116 includes a machine-readable medium 122 on which is stored instructions 124 (e.g., software) embodying any one or more of the methodologies or functions described herein. The instructions 124 (e.g., software) may also reside, completely or at least partially, within the main memory 104 or within the processor 102 (e.g., within a processor's cache memory) during execution thereof by the computer system 100, the main memory 104 and the processor 102 also constituting machine-readable media. The instructions 124 (e.g., software) may be transmitted or received over a network 126 via the network interface device 1220.

While machine-readable medium 122 is shown in an example embodiment to be a single medium, the term “machine-readable medium” should be taken to include a single medium or multiple media (e.g., a centralized or distributed database, or associated caches and servers) able to store instructions (e.g., instructions 124). The term “machine-readable medium” shall also be taken to include any medium that is capable of storing instructions (e.g., instructions 124) for execution by the machine and that cause the machine to perform any one or more of the methodologies disclosed herein. The term “machine-readable medium” includes, but not be limited to, data repositories in the form of solid-state memories, optical media, and magnetic media.

### Framework Overview

In the discussion which follows, efficacy, tolerability, and cost are referred to as the principal clinical dimensions (“PCD”). These are the three factors that physicians globally contemplate when they make a treatment decision for a patient. The disclosed configuration includes an Internet-based framework for sharing, validating, and visualizing structured medical knowledge that overcomes each of the aforementioned limitations simultaneously using an Internet-based social network.

In some embodiments, efficacy can refer to the ability of an intervention to produce the desired beneficial effect, or the ability of a drug or treatment to produce the desired therapeutic effect. Tolerability of a treatment can include an assessment of the side effects and the safety of the treatment. A treatment may be intolerable because it produces severe side effects or numerous side effects. Also, the treatment may not be tolerable because it causes safety issues, such as toxicity or serious health complications. Cost entails various measurements for the price of the treatment and can include costs borne by the individual patient or an overall cost of the treatment (e.g., drug, device, procedure). Costs can be measured by any applicable currency or unit (dollars, Euro, etc.) and by unit(s) or amount used for treatment per patient.

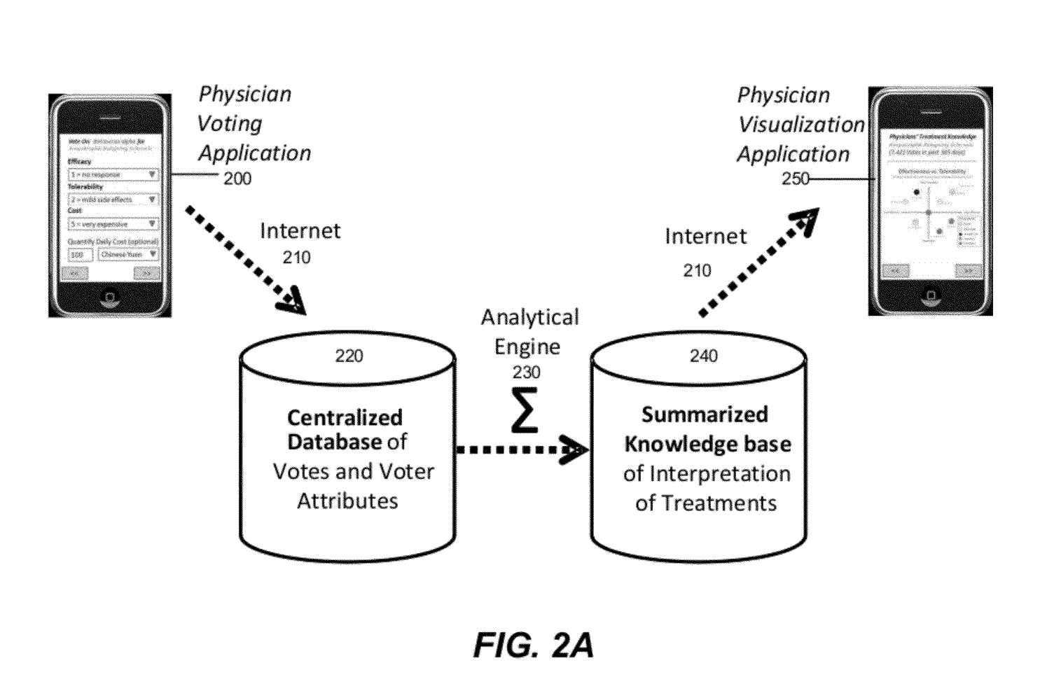

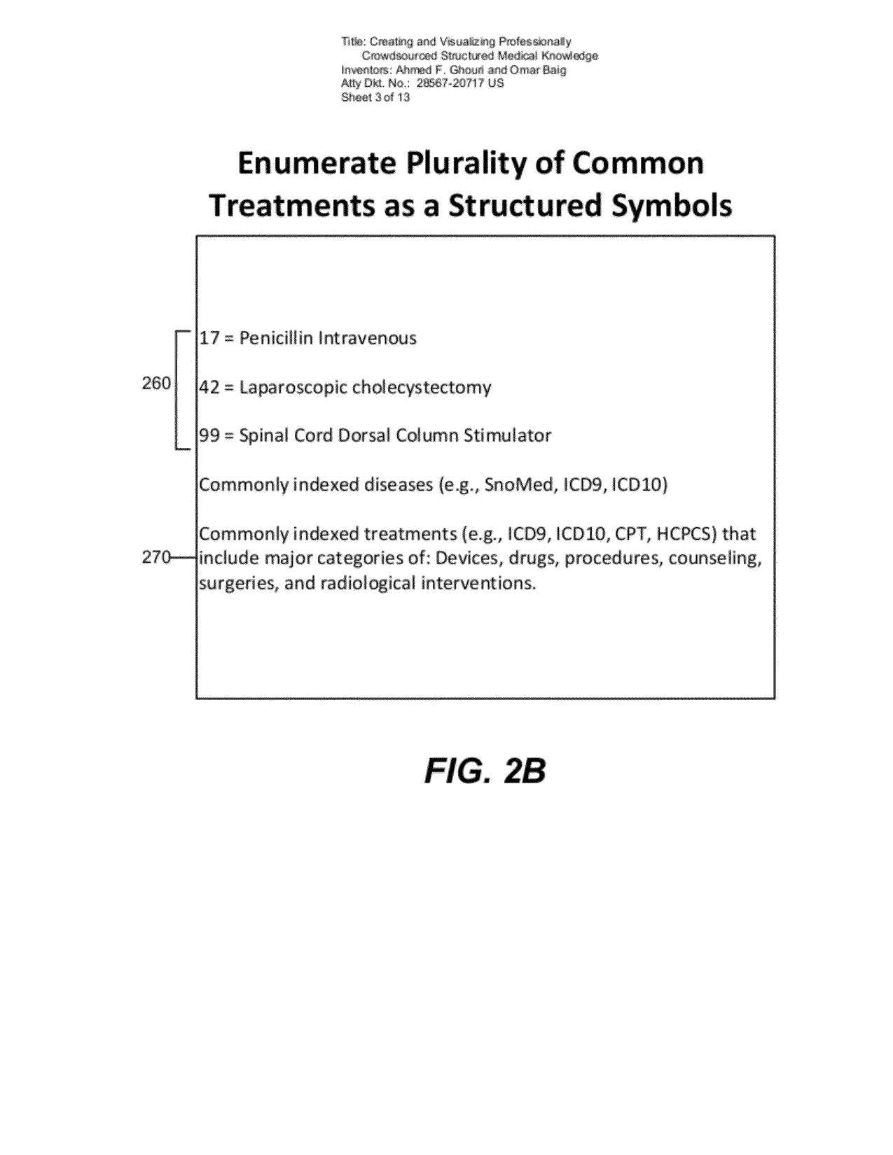

FIG. 2A illustrates one example embodiment of an information and flow in a system configuration for creating and visualizing structured medical knowledge on treatment efficacy, tolerability, and cost. For example, a software application 200 is configured to operate with a machine, such as a personal computer (PC), tablet computer, or smart phone. The software application 200 is configured to gather votes from a community of physicians, who are utilizing various treatments. An Internet-based communication mechanism 210 transmits votes on treatment efficacy, tolerability, and cost to a central server and database 220. A data mining analytical engine 230 continually processes the voting input data from a community of physicians. The voting input data is summarized, organized, and interpreted, and the results of the voting input data are stored in a summarized knowledge base 240. A physician visualization software application 250 retrieves the summarized results of the voting input data from the summarized knowledge base 240 and displays it using an intuitive visualization configuration. The visualization configuration 250 helps enable selective configuration and filtering by the viewer.

### Symbolic Structuring of Possible Diseases and Treatments

Referring to FIG. 2B, it illustrates one example embodiment of representative integers 260 that are used as symbols for common treatments. It should be noted that more than one dictionary of coded symbols may be employed, just not free text representations. The representation of all evaluated treatments and diseases are precise mathematical symbols, versus free text, both for searching and for voting during structured data entry by a physician, using a web-enabled computer (whether a desktop, tablet computer, or smartphone). Free text can be misspelled, truncated, and also abbreviated, making rigorous data mining difficult, if not impossible. The clinical categories are enumerated as symbols 260, including drugs, devices, procedures, counseling, surgeries, and radiological interventions 270. The method utilized to count and maintain these are described herein.

Initially, all known dispensable medications, their routes, and their forms are enumerated. An example of such a dictionary in the United States is RxNORM, published by the U.S. Library of Medicine as an open source, regularly updated database, e.g., weekly. Additionally, the FDA also publishes a daily update of newly approved therapies of any kind, including devices, drugs, radiology procedures, and lab tests.

Major industrialized countries typically have a similar regulatory approval agency, and most publish to the web new and approved products on a periodic basis, e.g., daily or weekly. While brand and generic names can vary by country, these can be normalized using internationally-accepted physiologic representations, such as the molecular structure of a drug as defined by a universal, open source key. For instance, the InChiKey, published by the International Union of Pure and Applied Chemistry (“IUPAC”), has a hash key that is based upon a fixed length (25 character) condensed digital representation of a chemical structure that is consistent across all languages, and can be thought of as a mathematical integer defined by a 3-dimensional molecule. The InChiKey is unique and completely unambiguous.

Similarly, all major diseases are classified according to precise physiological definitions. An example of such a dictionary is the International Classification of Disease (ICD9 and ICD10), published by the World Health Organization, which is also an open source database that is regularly maintained and published electronically, and is a worldwide open-source standard.

Such structure is relevant and of interest because during a voting session by a physician on the Principal Clinical Dimensions of efficacy and tolerability, only known symbols can be searched or voted upon, obviating the need for approximate matching of lexical variants of free text, including misspellings and/or acronyms such as “CHF” for “congestive heart failure”. Modern search engines make good utility of forcing structure on the user, by employing the method known as “Auto-Suggest”, in which only the search phrases known to the engine are presented to the user in real-time, obviating the need for empty search results.

As further described herein, one embodiment identifies representative medical dictionaries in the public domain that enable formal (symbolic) codification of medical concepts as structured data. In addition, their maintenance as new treatments and diagnoses are introduced over time. Further, structured data, as it pertains to treatments, diseases, and voting on their efficacy, cost, and tolerability is provides both user knowledge contribution and visualization. Structured data addresses the limitations of free text, which can be misspelled, abbreviated using acronyms, etc, and thereby allows meaningful data mining and graphical visualization of aggregated opinions. The described configurations helps address the issues observed from historical experiences that show one cannot data mine free text clinical data with any degree of accuracy, as exemplified by the limited utility of natural language processors in the medical profession.

### Physician Credentialing

Next, a system in accordance with the configuration disclosed herein has a voting physician to be previously credentialed by a strong algorithmic or human review process. For example, for electronic prescribing in the U.S., physicians are validated reliably within minutes by asking the registering physician to answer a series of detailed questions whose answers are only reasonably knowable by the actual doctor. Examples of such questions include medical school name and year of graduation, prior office addresses, prior hospital affiliations, prior tax identifications (TaxIDs), prior or existing coworkers, and regulatory license numbers. The combination of such data is not readily, or easily, known by others.

An alternative method of credentialing may employ transmission of a temporary password, following initial registration, to the official address of business according to a medical licensure database. To falsify the physician's identity on the network would require intercepting official Postal Service mail to the doctor, which can lead to severe legal penalties if done. Again, the specific threshold required for accepting the credentials of a physician who wishes to vote in the system might vary over time. At this stage, the system in summary considers physician credentialing as a prerequisite in order to vote on a treatment. Accordingly, the system renders trust by the viewers of the votes.

Acceptance of a physician's credentials is binary. Specifically, the system believes the Internet-based contributor is a physician or not. The credential status, according to the community aggregating comparative treatment votes, is thus either true or false for every registrant.

### Scoring and Recording of Physician Voting Bias

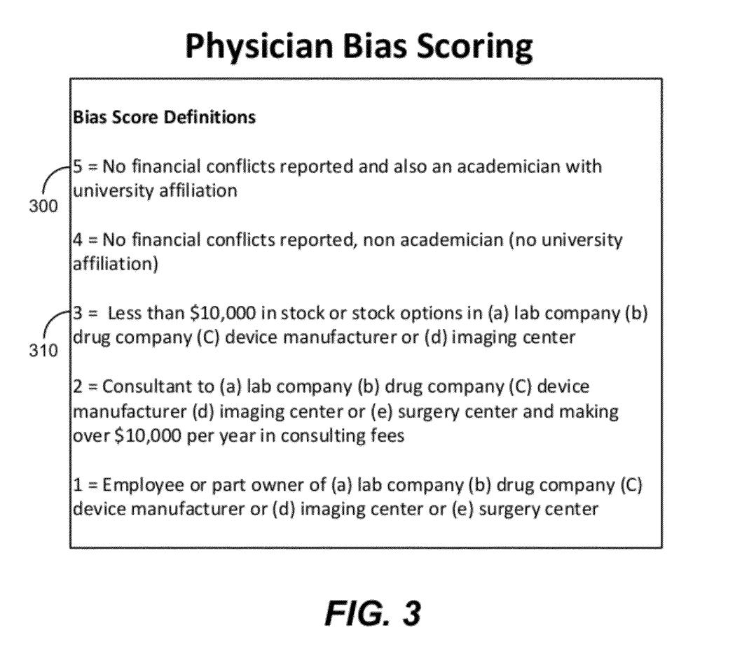

Referring next to FIG. 3, it illustrates one example of a physician bias scoring system. Specifically, among duly credentialed physicians, the system is configured to track and score a particular physician's potential voting bias. In one example, the system uses categorical scoring to evaluate bias of the physician. Bias scoring allows viewers of accumulated physician votes to filter their views dynamically, based on desired levels of biases to be excluded. For example, a user may only wish to see votes of physicians who have no reported financial ties to industry and who are pure academicians 300. The user may choose to see votes from physicians whose ties are relatively small (e.g., less than $10,000 U.S. dollars per year in earnings from consulting fees to industry 310).

It is understood that the scoring of bias may change from time to time, for example, the dollar amount required as the threshold of consulting fees might change from $10,000 per year to $15,000 per year, to adjust for inflation. In sum, the system is configured to selectively filter votes according to varying levels of bias using a transparent classification system.

### Voting Velocity Governance

An additional aspect of bias reduction is quantitative voting reliability. A physician's voting reliability can be assessed by determining the voting history of the physician. A voting history can include a voting velocity (e.g., number of votes submitted in a given amount of time), a clinical dimension (e.g., number of patients treated), or a volume of experience (e.g., number of years or number of treatments performed) of the physician.

For example, a physician may state that she is reporting on experience in 1,000 patients she has treated in the past 90 days. The figure of 1,000 patient experiences by one doctor in such a short time interval can be unreliable for at least two reasons. First, the doctor may be a part owner of a company that makes the treatment being evaluated (i.e., is intentionally gaming the voting system). Second, the physician may have made an honest mistake, meaning to enter “100” and not “1000” on a keyboard. The disclosed configuration corrects for both aspects by governing the rate of voting in a unit interval of time that is plausible for the physician across all his/her votes.

In another example, if a surgery typically takes 2 hours, it is not possible to perform an average of 20 per day in by an ordinary human being. This time versus volume criteria is amortized across all votes by the doctor in a given time interval. For example, a physician might be able to perform 100 surgical procedures A or 100 surgical procedures B in a period of 30 days, but not both. If a physician exceeds predefined thresholds for plausibility, he/she can be asked to verify the volume before submission as being practically unlikely. If the physician overrides the warning, a maximum pro-rata percent of all votes is automatically taken across all votes, based on a ceiling that is possible in terms of human time available during the time interval across all procedures the doctor has voted on during that time interval. By way of example, a system as disclosed enumerates a minimal time required for each procedure in its inventory of possible procedures. Furthermore, it can be assumed that a physician works no more than 18 hours per day, 7 days per week, on average. This can be visualized as the following, in the case of surgeries:

| Procedure | Minimal Time |
|---|---|
| Surgery A | 90 minutes |
| Surgery B | 75 minutes |
| . . . | . . . |
| Surgery Z | 25 minutes |

It should be noted that an analogous velocity can be construed for other treatments, such as medications. For example, a physician will only generally write up to 15 prescriptions per patient per day, averaged across all patients. Therefore, the disclosed configuration comprises two voting-related safeguards: first, prompting the voting physician when a vote number seems excessive, and if overridden, adjust all a physician's accumulated votes proportionately to the maximum amount of time a physician could plausibly spend with a patient per day, on average.

By way of example, suppose a physician claims to have performed 500 of Procedure A, and 400 of Procedure B in the same 30 day time interval, in which both Procedure A and B take a minimal of 1 hour to perform. An 18-hour workday, 7 days a week equates to a maximum of 540 workable hours per month. The maximum number of votes for the month is thus 540. In this case, 400/(500+400), or 44.4 percent of 540 maximal votes would be automatically assigned to Procedure A, and 500/900, or 55.5 percent of the 540 maximal votes would be assigned to Procedure B. This would algorithmically translate into 240 votes for Procedure A, and 300 votes for Procedure B.

### Standardization of Patient Attributes

Next, the system is configured to standardize like-patients for comparison purposes before physician voting ensues. It is not medically plausible to compare a treatment in a young individual against another treatment in an elderly individual, because human physiology is expected to change over time. The same is true for gender. Additionally, treatment efficacy should be voted upon in light of the same severity of an illness. A treatment for an early stage illness may be more effective than advanced illness. By way of example, use of high-dose steroids in severe autoimmune disease might be quite effective compared to ordinary aspirin, but carry a high risk of side effects. Conversely, relative to tolerability, aspirin might be much better than steroids in mild disease, due to its benign clinical profile in ordinary doses. Therefore, treatments should be compared with regard to efficacy, tolerability, and price, only in patient groups that have similar (1) gender, (2) age, and (3) severity of illness. In some embodiments, additional patient characteristics can be identified and used for classification and comparison, such as pre-existing conditions (e.g., diabetes, high blood pressure, autoimmune conditions), physical attributes (e.g., weight, mobility), or medical history (e.g., previous surgery, treatment with other medications, recurrent infection). A challenge, therefore, is how to universally classify several thousand different diseases into a functional classification system that is simple enough to be of high utility, yet enable rapid physician voting.

The system utilizes a disease severity scoring system that can be ubiquitously applied to virtually any diagnosis and is transparent, convenient, and yet sufficiently precise to be used by physicians worldwide, and for nearly any illness. This is a functional disease severity classification system, which associates a disease to its practical impact on a patient's activities of daily living, and is easy for most physicians, regardless of language or geography, to grasp. It ranks each disease's severity level to a five-level hierarchy of the functional disease impact on the patient (in terms of the effect of the disease on a patient's activity, whether physical or mental).

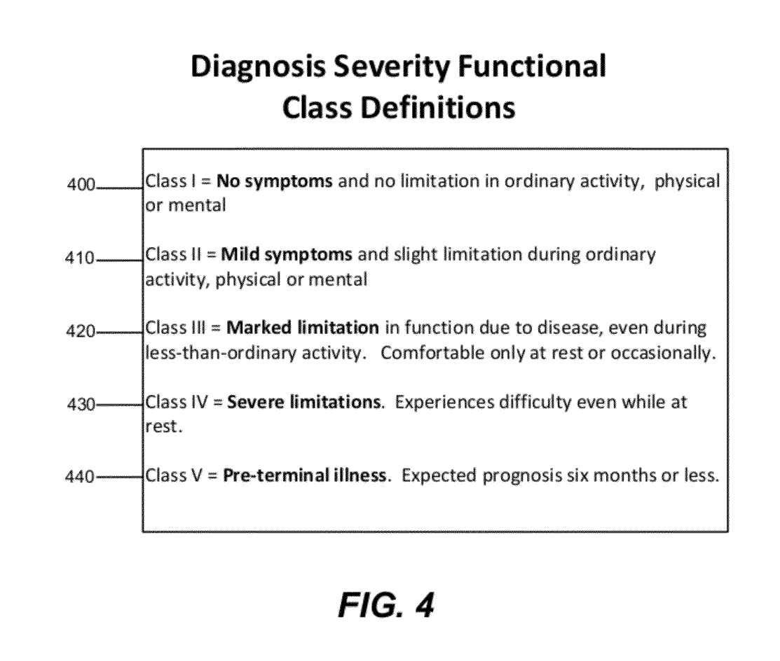

FIG. 4 illustrates one example of a high clinical utility, functional disease classification system. In virtually all diseases, the effect of the disease can be meaningfully quantified as an approximate indicator of the severity of the illness using a common definition scalable to all diagnoses or diseases. The disease severity scale employed in the disclosed configuration contains five Functional Severity Classes (Classes I to V, as shown in 400-440 respectively in FIG. 4). For example, Class 1400 can include patients with no symptoms and no limitation in ordinary physical or mental activity. With these consistent definitions, a physician can suitably describe a patient in terms of age, gender, disease, and functional disease severity before casting his or her vote for a treatment's efficacy, tolerability, and cost used for that diagnosis.

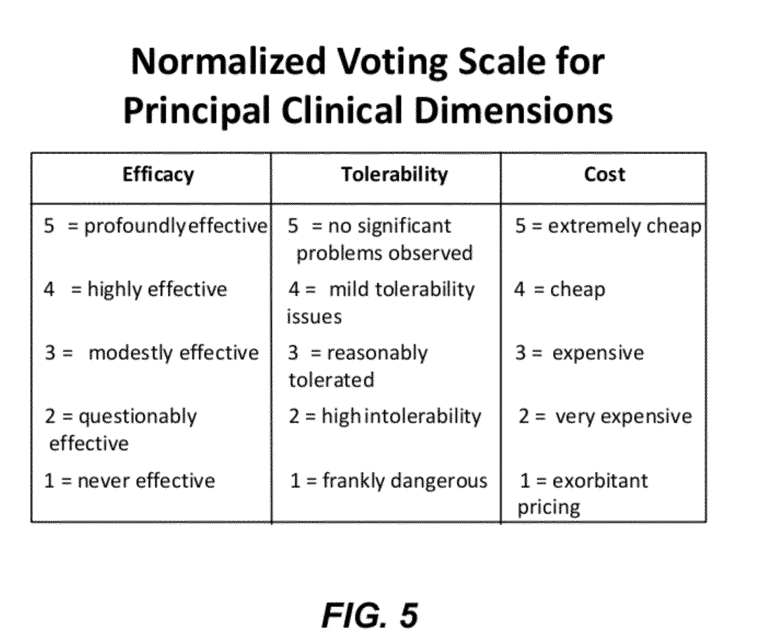

In a manner similar to the severity of illness classification system, a universally understood methodology is defined for the Principal Clinical Dimensions (PCD). Specifically, FIG. 5 illustrates one example embodiment of a normalized voting scale for principal clinical dimensions. In particular, a hierarchy is defined from 1 (never effective) to 5 (profoundly effective) for efficacy, for tolerability (from 1 (frankly dangerous) to 5 (no significant problems observed)) and for cost, from 1 (exorbitant pricing) to 5 (extremely cheap). Other classifications for the degrees of efficacy, tolerability, or cost can be used in a similar scale. The five-level classification system is employed to further acclimate the community of users to a common definitional framework across all treatments, diseases, efficacy, cost, and tolerability. A lack of suitable standards to date has precluded consistent computable knowledge sharing, across languages and diseases. As a consequence, it has not previously been practical to enable computable (mine-able) collective physician experiences that specifically address head-to-head comparisons of treatments that were never formally designed to compete against each other in a clinical trial. By standardizing patient attributes, as well as severity of illness, and desired endpoints in the three principal clinical dimensions, the system overcomes this limitations and scales arbitrarily from a semantic perspective.

### Voting According to Principal Clinical Dimensions and Volume of Experience

In one embodiment, the system includes a software application interface for physicians to cast votes on each of the principal clinical dimensions, in a well characterized set of patients based upon the crucial attributes of age, gender, disease, and functional severity. Age is most intuitively categorized in terms of decade of life since birth. This is both convenient and physiologic. It is not necessary to compare patients of the exact same year of birth, as this would unduly increase the data volume required for statistical analysis. Indeed, the unique combination of a quantitative age range, gender, diagnosis, and functional severity of the diagnosis can be mathematically considered to be a like-patient eigenvector for treatment comparisons across the entire universe of physician experiences, for all diseases and all treatments.

In one embodiment, a voting paradigm is also able to enter a specific number of patient experiences to date, and votes for each of the principal clinical dimensions. The number of patients treated is extremely critical from the perspective of performing rigorous statistical analysis of the information gathered. Hence, a physician should be able to quantify his or her volumetric experience before voting for a treatment.

Treatment Score Enhancement with Time

The value of treatments, in particular surgery, becomes better over time with experience and familiarity. For example, the first kidney transplants were difficult technically and had high complication rates. However, with practice, they became routine, highly effective, with rare complications, and are now a Gold Standard for end stage renal failure patients. Additionally, the same is true with medications. Initially, dosing recommendations with a new drug can be too high or too low, due to lack of experience. A dose that is too low may falsely manifest as weak efficacy, and a dose that is too high can falsely manifest as intolerable due to dose-dependent side effects. Once dosing expertise is developed, the inherent value of the drug may truly emerge over time with experience.

To reflect this maturing of expertise over time, as measured by tolerability and efficacy, a system enables a physician user to view the community votes on treatments by excluding votes that are older than a desired time frame. For example, a physician may only wish to see the sum of doctors' experiences on head-to-head treatment gathered only during the past 24 months, and exclude votes greater than 24 months in age from the time they were initially cast. In one embodiment, the system explicitly enables this in its visualization parameters, as discussed below.

### Voting User Interface

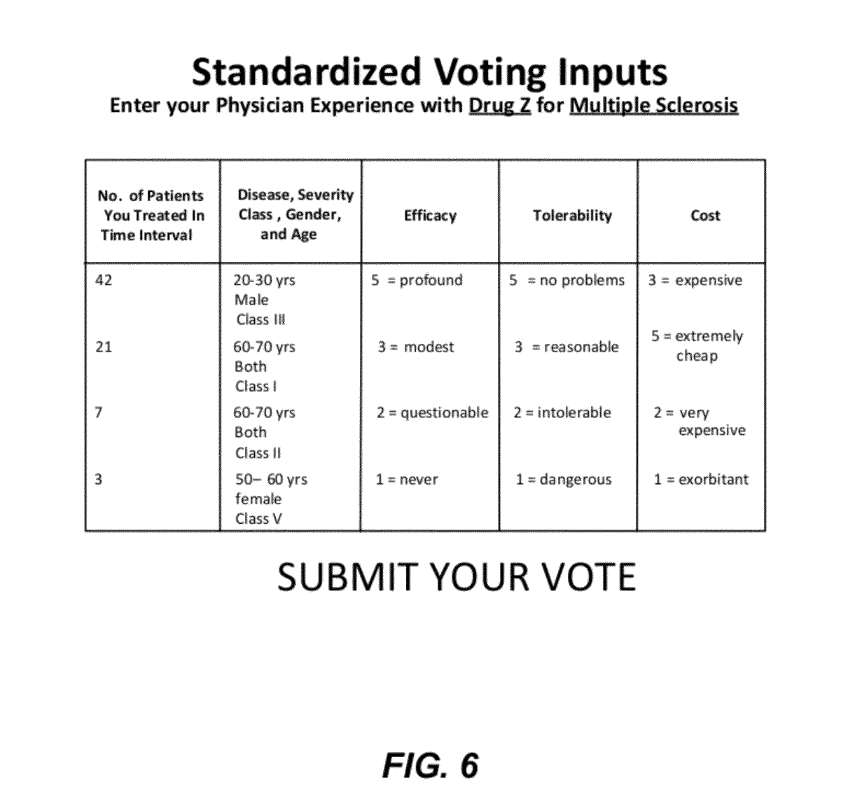

In terms of a user experience, FIG. 6 illustrates one example embodiment of a voting screen that a user may interact with on computing system 100. It can be seen that there is a structural requirement to define the precise group of patients for whom a treatment is being evaluated. In this example, a physician is casting his or her vote for a specific Drug Z for the disease multiple sclerosis. A total of 73 patients were treated by the physician in a period of one month, in four distinct patient groups, according to an embodiment of a system as disclosed herein. For each distinct patient group of this disease (multiple sclerosis), the Drug Z was employed by the treating physician. For speed of voting, the possible values are enumerated in a drop-down list, making the voting interaction by the physician extremely rapid.

The ultimate utility of this physician voting system is visualization of head-to-head treatment comparisons, in similar patients, with regard to efficacy, tolerability, and normalized cost. Cost is the easiest dimension to normalize, as the physician can state the per day cost of therapy using any local currency, which can be translated into any other standardized unit of currency. For convenience, the disclosed configuration uses U.S. dollars, as it is a common benchmark, although any currency could be displayed as a matter of configuration and language preference.

It should be noted that a voting physician may only vote on a single therapy. In one embodiment, the system is configured to summarize all treatments for the disease, in like patients, using normalized parameters, creating a virtual head-to-head comparison algorithmically, and immediately. This capability is in direct contrast with contemporary studies, which are typically months to years old, due to cumbersome administrative, formatting, and manual review processes prior to publication. Indeed, even online journals are encumbered by these issues, because there are no commonly accepted, standardized methods for normalizing patient data and disease severity across different sets of experiences for a vast library of diseases and treatments. Furthermore, clinical trials as they are employed today have a clear, a priori notion of which treatments are to be compared. In the disclosed configuration, any treatment that has been tried can be added to the comparative analysis by any credentialed physician. Indeed, at least 25% if not higher, of all treatments employed are off-label uses, for indications they have not been formally approved for by local regulatory authorities.

Today, there is no efficient method to determine what a community of physicians uses in an off-label fashion, other than expensive surveys that represent a small statistical sampling. In one embodiment, the system removes the economic barriers to gathering this information by leveraging an Internet-based physician social network, which has a near-zero cost of distribution.

### Configuration Setting Prior to Visualization

In addition to credentialing, bias reduction, and structured clinical semantics of voting, the economy and intuitiveness of visualization is an important attribute of the disclosed configuration. Visualization must be quick, and results user-obvious, to be quickly used by physicians, especially when more than a dozen treatments might be evaluated for many thousands of diseases in dozens of patient subgroups.

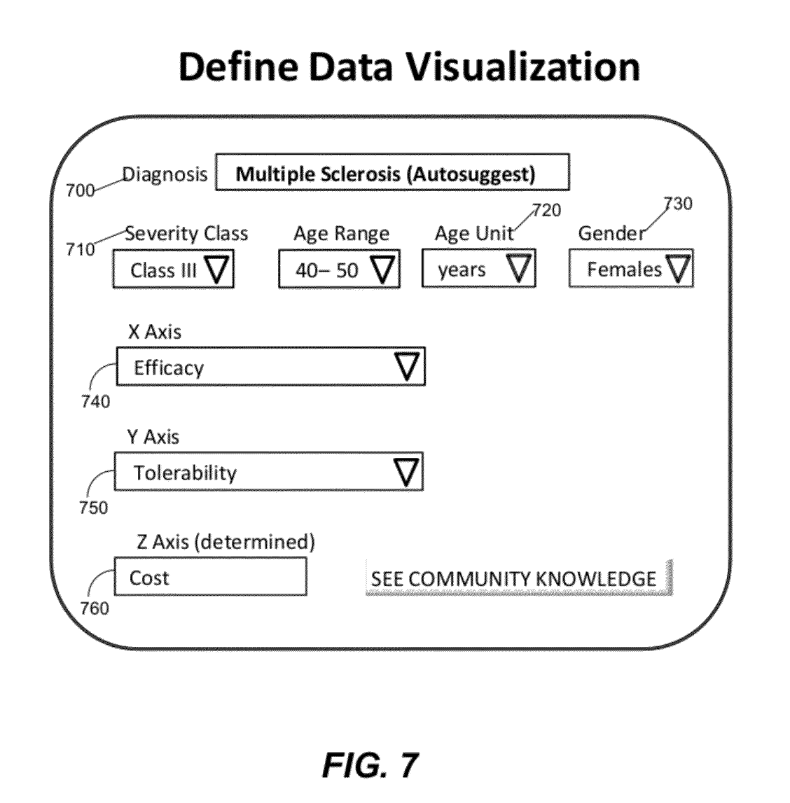

FIG. 7 illustrates an example embodiment of an interface for defining data visualization. For example, a user can define a query that enables the user to view the totality of network knowledge, for a given disease or diagnosis 700, severity 710, age group 720, gender 730, and across all voted upon treatments for a patient group, as of that moment in time. For example, a physician could request to see all reported treatments for Severity Class III Multiple Sclerosis in 50-60 year old females, and their comparative efficacy 740, tolerability 750, and cost 760, across the entire community as a single view.

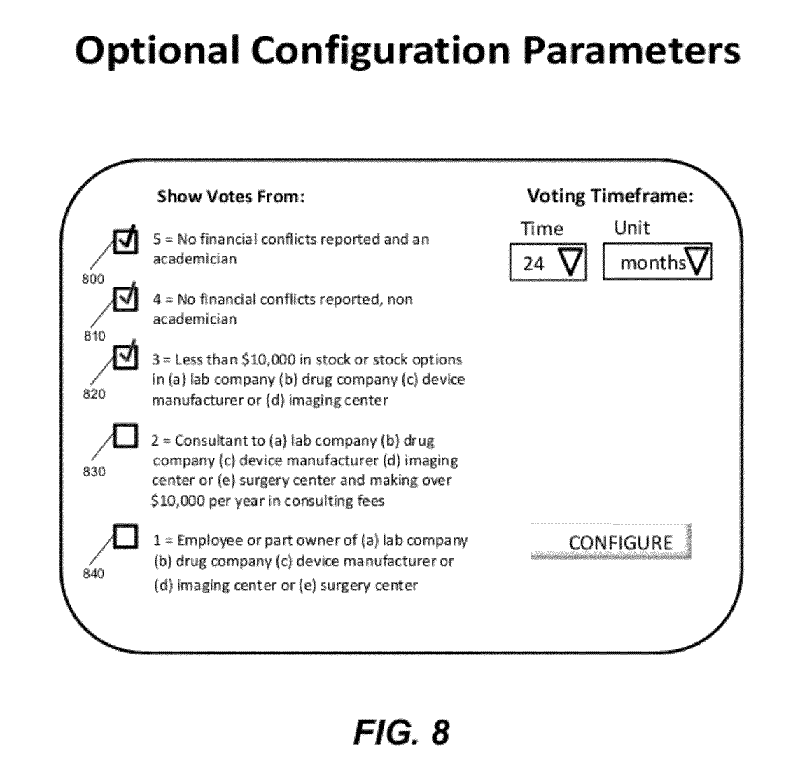

FIG. 8 illustrates one example embodiment to further refine a query. By way of example, a user can optionally request to remove from the analysis and visualization the votes of biased physicians as defined by a bias threshold desired by the user, as shown in FIG. 8. For example, the user may only want to see votes from physicians categorized with financial biases of the categories 5, 4, or 3 (800, 810, 820 respectively in FIG. 8), but no lower (830, 840). The specifics of the definitions of financial bias may change with time (e.g., adjustment for inflation), without deviation from the spirit and intent of the disclosed configuration. In addition to bias filtering, the user may only wish to see votes cast in a specified time interval (e.g., the past 24 months), for example, to allow for familiarization with therapeutic procedures and optimal experience in the dosing and administration of medications.

### Visualization Method

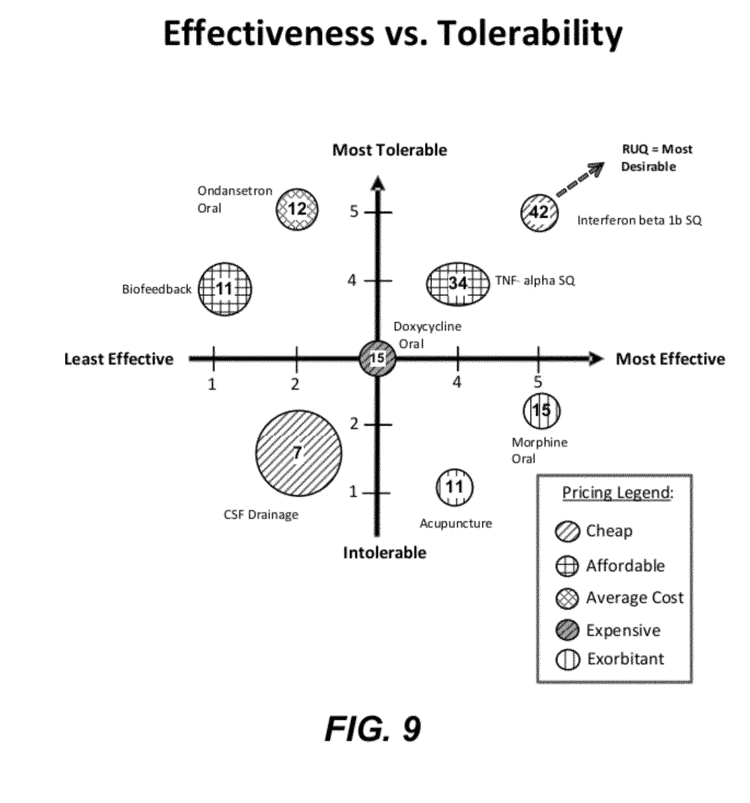

After the desired patient eigenvector is generated for viewing of community votes, one embodiment of the disclosed configuration defines a simple visualization method that is user-obvious in its nature and readily accessible to the everyday clinician. FIG. 9 illustrates one example embodiment of a user interface generated to illustrate effectiveness of treatment (X-axis) to tolerability (Y-axis). In particular, the system defines a Cartesian view in which all treatments can be immediately visualized as ellipses on a plane, with the X and Y axis user defined as two of the three principal clinical dimensions (efficacy, tolerability, or cost). For any desired output, treatments that are the furthest to the top and furthest to the right are by definition the most desirable. Hence, a busy clinician can very quickly see, with minimal interpretation effort, what works best. Treatments in the right upper quadrant are the most superior, by consistent definition, across all diseases and the two key dimensions visualized.

A second aspect of the visualization methodology is a centroid of an ellipse for a given treatment, and its vertical length and horizontal width, as shown in FIG. 9. The centroid of the ellipse represents the mean value of all votes for the treatment in each of the two dimensions. For example, the treatment “TNF-alpha SQ” has a mean value of 4.0 in terms of efficacy, and 4.0 in terms of tolerability. The number in the centroid of the ellipse is the number of votes cast for that treatment, which may be in various units for reading convenience (e.g., tens, hundreds, thousands, etc.). The vertical height of the ellipse represents exactly two standard deviations from the mean in the Y-dimension. The horizontal width similarly represents exactly two standard deviations from the mean in the X-dimension. This helps to quickly show the consistency of votes for a treatment (e.g., the tightness of clustering increases confidence in consistent physician opinions).

Another aspect of the visualization of the disclosed configuration is the flattening of the third dimension. This greatly enhances readability and is ideally a color coded schema for rapid interpretation, although other icons (hatch marks, lines, etc.) may be used. This is presented as a legend to accompany the 2D plane. Although a 3D graph may be used, it is non-intuitive to show standard deviations from the mean as spheres and yet still be readable.

Through FIG. 9, it can be observed that choosing efficacy as the X axis, and tolerability as the Y-axis, forces flattening of the 3rd dimension (cost) into the legend. Cost is then shown as the color coding or marking of the ellipse itself. With repetitive use, the user community will become ‘trained’ to the logically consistent paradigm of the coding system, regardless of which dimension is chosen. Similarly, and by design, each dimension, including disease severity classes, are intuitively set to a five point scale, to reinforce usability across all diagnoses (e.g., severity class) and perceptions of value.

It should be stated that the computation of comprehensive community knowledge is ideally performed on a continuous basis, ranging from minutes to hours, depending on the size of the dataset. For example, a modern search engine updates its interpretation of the entire web's collection of web pages approximately daily. In one embodiment, a disclosed configuration utilizes a similar batch computation process at least on a daily basis, to remain as current as possible. The frequency of computation is not material to the disclosed configurations, except to state that it should be done on a continuous basis as often as is practicable to avoid information latency. Daily analysis in a batch mode process is the preferred compromise between user experience performance and risk of obsolescence.

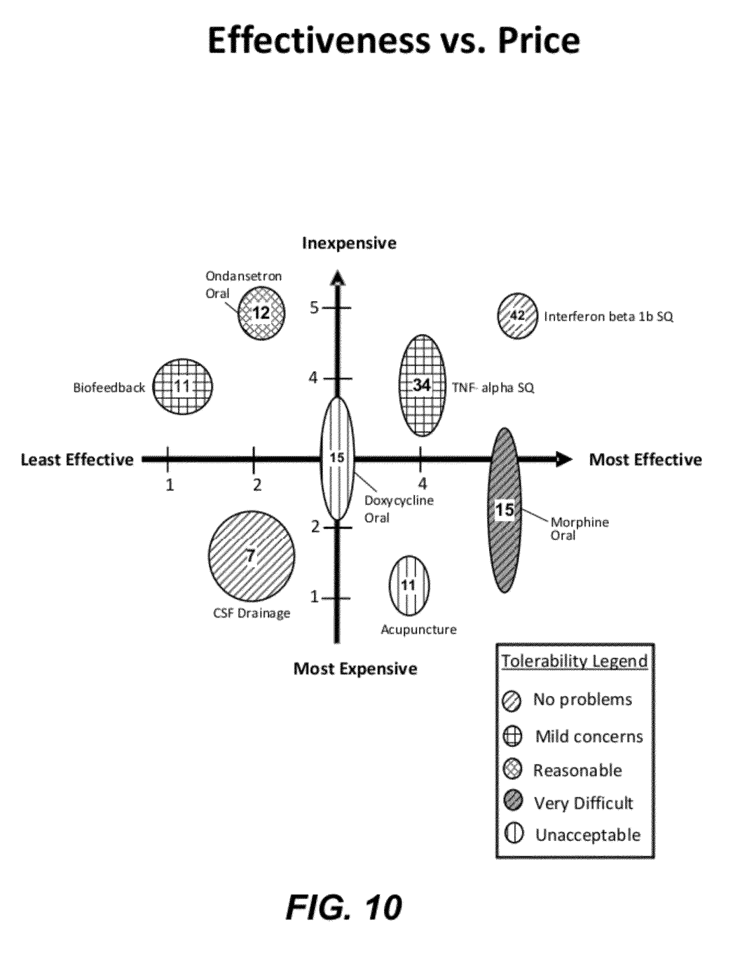

FIG. 10 illustrates one example embodiment of a user interface generated to illustrate effectiveness of treatment to price. Specifically, FIG. 10 shows an example where tolerability is substituted for price in the Y-axis. In this case, tolerability is denoted by the color or markings of the ellipse, and the vertical height (but not horizontal width) of each ellipse (treatment) changes accordingly to the new dimension and its variation. In this example, 15 votes for morphine oral have a wide price variation because both brands and generics have been co-mingled into a single ellipse. The disclosed configuration allows for separation of the cost dimension into branded and unbranded versions of the identical treatment, in this case, morphine oral.

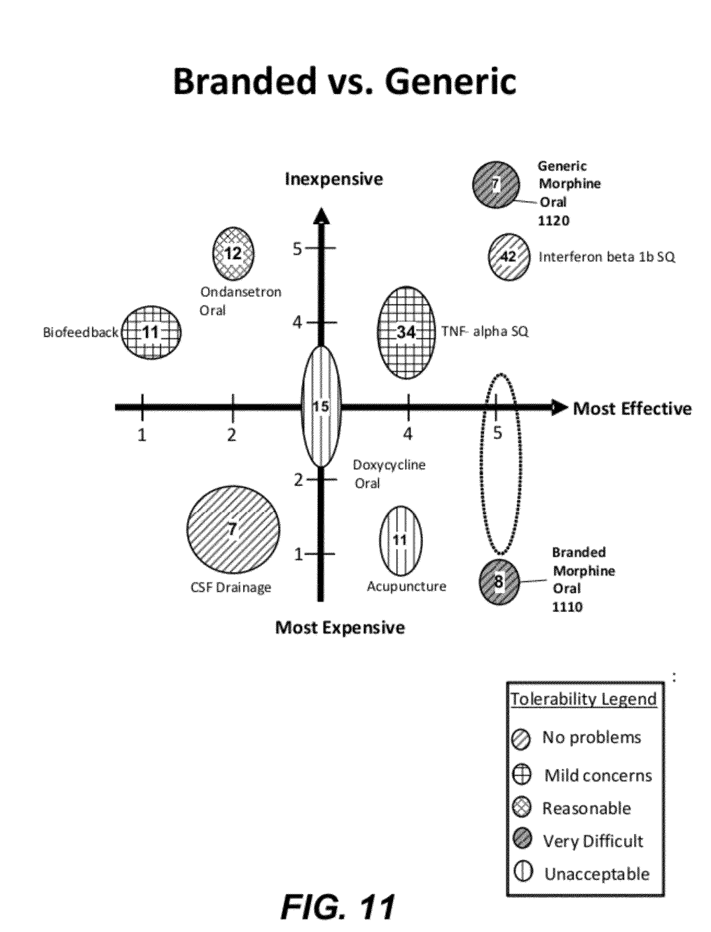

FIG. 11 illustrates a variation of FIG. 10, excepting that cost has been selected specifically to break apart branded versus generic versions of the treatment, morphine oral. In particular, FIG. 11 illustrates one example embodiment of a user interface generated to illustrate effectiveness of treatment with respect to branded or generic treatment solutions. Choosing a generic vs. brand view, as illustrated in FIG. 11, splits morphine oral into essentially two different treatments from a conceptual perspective. This can be especially important for the cost dimension. This creates two ellipses 1110, 1120, with numerical counts of 8 and 7 respectively, adding to 15. As shown in FIG. 11, generic morphine is very effective and very affordable. The differences between generic and branded morphine oral were not visible when the data for the cost of brand or generic treatments were combined.

In view of the disclosures herein, it is understood that a physician can request a community view of treatment efficacy just before, or during, a patient encounter at the moment of decision making, in order to obtain a real-time, crowdsourced view of comparative treatment efficacy from physicians worldwide.

### Computing Machine Architecture

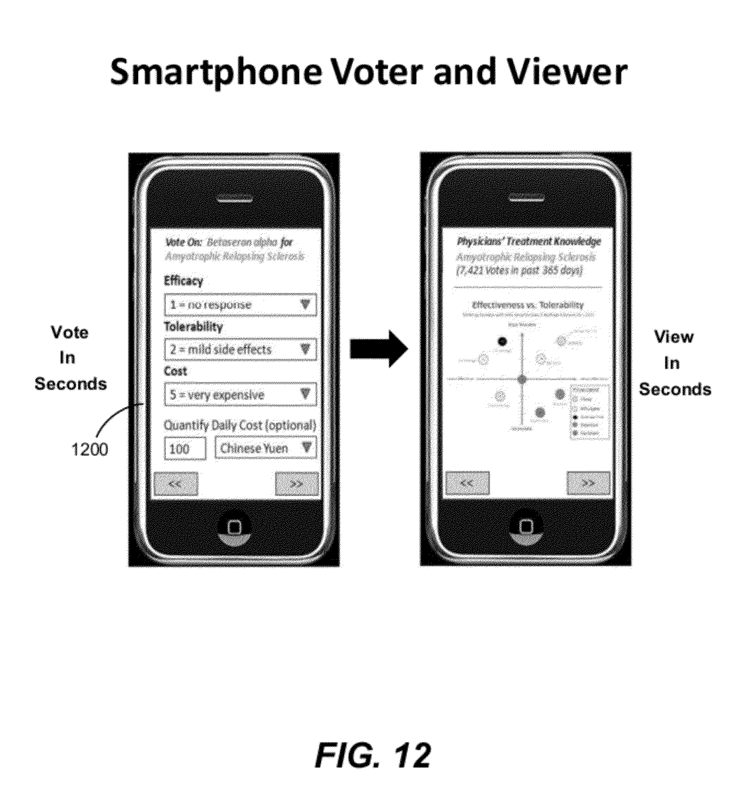

It should be understood by those familiar in the art that the computerized platform of choice for voting and visualization can be any machine with an Internet (or like) network connection, for example a desktop computer or tablet person computer (PC). For example, FIG. 12 illustrates one example embodiment of a user interface generated on a smart phone 1200 for use of the configurations as disclosed for both voting purposes and visualization. In such an example, a smart phone enables physicians to vote during, or just after, a patient encounter, when they have just witnessed the efficacy of a treatment. This level of portability allows a physician to vote essentially synchronously with his or her observation of a patient during a face-to-face encounter.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the structure and operation of the disclosed configurations. This description should be read to include one or at least one and the singular also includes the plural unless it is obvious that it is meant otherwise.

Upon reading this disclosure, those of skill in the art will appreciate still additional alternative structural and functional designs for a system and a process for creating and visualizing professionally crowdsourced structured medical knowledge through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for creating and visualizing structured medical knowledge, the method comprising:
verifying the credentials of each of a plurality of physicians;
receiving a plurality of inputs from the plurality of physicians, the plurality of inputs comprising one or more votes from each of the plurality of physicians and the votes comprising scores for an efficacy, a tolerability, and a cost of a treatment for an indication or a disease;
determining reliability of each of the plurality of inputs by determining a voting history for each physician;
for a plurality of reliable inputs, analyzing scores for the efficacy, tolerability, and cost of the treatment for the indication or the disease; and
providing a visual representation of data to a viewing user, the visual representation comprising scores for efficacy, tolerability or cost of the treatment.

2. The computer-implemented method of claim 1, further comprising requiring the user to select from one or more structured data inputs for the indication or the disease.

3. The computer-implemented method of claim 1, further comprising providing the user with one or more structured data inputs for the scores for efficacy, tolerability, or cost of the treatment.

4. The computer-implemented method of claim 1, wherein determining the voting history comprises determining a voting velocity, a clinical dimension, or a volume of experience of the physician.

5. The computer-implemented method of claim 1, wherein providing the visual representation of the data to the viewing user comprises presenting data for one or more selected indications or diseases.

6. The computer-implemented method of claim 1, wherein providing a visual representation of the data to a viewing user comprises presenting data for at least two of the following parameters: efficacy, tolerability, or cost of the treatment.

7. The computer-implemented method of claim 1, wherein analyzing scores for the efficacy, tolerability, and cost of the treatment comprises averaging the scores for each of the efficacy, tolerability, or cost of the treatment.

8. A computer-implemented method for creating and visualizing structured medical knowledge, the method comprising:
receiving a plurality of inputs from a plurality of users, the inputs comprising structured data inputs for an efficacy, a tolerability, and a cost of a treatment for an indication or a disease;
verifying that each of the plurality of users is a physician;
for each of the plurality of inputs:
determining reliability of the input;
analyzing the data about the treatment for the indication or the disease; and
presenting for display a visual representation of the data to a viewing user, the visual representation comprising scores for efficacy, tolerability or cost of the treatment.

9. The computer-implemented method of claim 8, wherein verifying that each of the plurality of users is a physician comprises analyzing the credentials of the user.

10. The computer-implemented method of claim 8, wherein determining reliability of the input comprises determining a voting velocity of a physician using limits for plausibility of the input by the physician.

11. The computer-implemented method of claim 8, wherein determining reliability of the input comprises determining a clinical dimension or a volume of experience of a physician.

12. The computer-implemented method of claim 8, further comprising requiring the user to select from one or more structured data inputs for the indication or the disease.

13. The computer-implemented method of claim 8, further comprising requiring the user to select from one or more structured data inputs for a severity or a class of the indication or the disease.

14. The computer-implemented method of claim 8, further comprising requiring the user to select from one or more structured data inputs for an age or a gender of a patient.

15. The computer-implemented method of claim 8, further comprising providing the user with one or more structured data inputs for the scores for the efficacy, tolerability, or cost of the treatment.

16. The computer-implemented method of claim 8, wherein analyzing the data about the treatment for the indication or the disease comprises:
aggregating the data for each of a plurality of scores for efficacy, tolerability, or cost of the treatment; and
determining an average score for each of the efficacy, tolerability, or cost of the treatment.

17. The computer-implemented method of claim 16, wherein providing a visual representation of the data to a viewing user comprises a graphical representation of at least two of the averaged scores for efficacy, tolerability or cost of the treatment.

18. The computer-implemented method of claim 17, further comprising presenting a visual representation of data for a comparison of at least two different treatments for the indication or disease.

19. The computer-implemented method of claim 8, wherein presenting for display a visual representation of the data to a viewing user comprises presenting data for the efficacy of a branded treatment to a generic treatment for the indication or disease.

20. A non-transitory computer-readable storage medium storing executable computer program instructions for creating and visualizing structured medical knowledge, the computer program instructions comprising:
receiving a plurality of inputs from a plurality of users, the inputs comprising structured data inputs for an efficacy, a tolerability, and a cost of a treatment for an indication or a disease;
verifying that each of the plurality of users is a physician;
for each of the plurality of inputs:
determining reliability of the input;
analyzing the data about the treatment for the indication or the disease; and
presenting for display a visual representation of the data to a viewing user, the visual representation comprising scores for efficacy, tolerability or cost of the treatment.

21. The computer-readable storage medium of claim 20, wherein verifying that each of the plurality of users is a physician comprises analyzing the credentials of the user.

22. The computer-readable storage medium of claim 20, wherein determining reliability of the input comprises determining a voting velocity of a physician using limits for plausibility of the input by the physician.

23. The computer-readable storage medium of claim 20, wherein determining reliability of the input comprises determining a clinical dimension or a volume of experience of a physician.

24. The computer-readable storage medium of claim 20, further comprising requiring the user to select from one or more structured data inputs for the indication or the disease.

25. The computer-readable storage medium of claim 20, further comprising requiring the user to select from one or more structured data inputs for a severity or a class of the indication or the disease.

26. The computer-readable storage medium of claim 20, further comprising requiring the user to select from one or more structured data inputs for an age or a gender of a patient.

27. The computer-readable storage medium of claim 20, further comprising providing the user with one or more structured data inputs for the scores for the efficacy, tolerability, or cost of the treatment.

28. The computer-readable storage medium of claim 20, wherein analyzing the data about the treatment for the indication or the disease comprises:
aggregating the data for each of a plurality of scores for efficacy, tolerability, or cost of the treatment; and
determining an average score for each of the efficacy, tolerability, or cost of the treatment.

29. The computer-readable storage medium of claim 28, wherein providing a visual representation of the data to a viewing user comprises a graphical representation of at least two of the averaged scores for efficacy, tolerability or cost of the treatment.

30. The computer-readable storage medium of claim 29, further comprising presenting a visual representation of data for a comparison of at least two different treatments for the indication or disease.

31. The computer-readable storage medium of claim 20, wherein presenting for display a visual representation of the data to a viewing user comprises presenting data for the efficacy of a branded treatment to a generic treatment for the indication or disease.
